(19) United States
(12) Patent Application Publication
(10) Pub. No.: US 2008/0260275 A1
(43) Pub. Date: Oct. 23, 2008

(54) Image Coding Apparatus

(76) Inventors: Ikuro Ueno, Tokyo (JP); Toshiyuki Takahashi, Tokyo (JP); Masayuki Yoshida, Tokyo (JP); Fuminobu Ogawa, Tokyo (JP)

Correspondence Address: BIRCH STEWART KOLASCH & BIRCH, PO BOX 747, FALLS CHURCH, VA, 22040-0747, US

(21) Appl. No.: 11/579,453

(22) PCT Filed: May 17, 2004
(86) PCT No.: PCT/JP2004/06974

§ 371 Date: Nov. 2, 2006

(51) Int. Cl. H04N 1/41

(52) U.S. Cl. 382/249

(57) ABSTRACT

An image coding apparatus includes a rate control information extraction means for determining which up to a coding pass in which code block should be coded from the sum of the code amounts of the code blocks, the slope of an RD curve calculated from the distortion difference between a coding distortion at a time of coding each coding pass and a coding distortion at a time of coding a preceding coding pass, and the number of output bytes of the code amount of each coding pass, and the inverse of one of given rate control parameters which are listed in order of decreasing monotonously, and for outputting an end-of-coding pass, and a coded data extraction means for reading coded data including up to coded data corresponding to the end-of-coding pass, for adding the number of coding passes to the coded data, and for outputting them as a code stream.

### FIELD OF THE INVENTION

The present invention relates to an image coding apparatus which carries out entropy coding.

### BACKGROUND OF THE INVENTION

Currently, the use of a static-image coding algorithm called JPEG (Joint Photographic Experts Group) has been widely spread mainly in the Internet. On the other hand, in order to provide next-generation coding systems, the JPEG2000 project has been newly started since 1997 by a joint committee of ISO and ITU against the backdrop of requirements of a further improvement in performance and an addition of functions. The main technical specifications about JPEG2000 Part 1 which defines the basic system of the above-mentioned JPEG2000 algorithm were finally established in December, 2000. The outline of the basic system of the JPEG2000 coding algorithm will be explained hereafter according to the recommendation (ISO/ITU 15444-1:2000).

First, a two-dimensional wavelet transform is performed on an input image signal by a wavelet transform unit, and the image signal is split into a plurality of subbands, and a wavelet transform coefficient for each subband is generated. The two-dimensional wavelet transform is implemented as a combination of one-dimensional wavelet transforms. In other words, the two-dimensional wavelet transform processing includes a process of performing a vertical one-dimensional wavelet transform in turn for every column and a process of performing a horizontal one-dimensional wavelet transform in turn for every row.

FIG. 1 is a diagram showing a conventional wavelet transform. A one-dimensional wavelet transform is implemented by a low-pass filter, a high-pass filter, and down samplers having predetermined characteristics, as shown in FIG. 1(a). As shown in FIG. 1(b), subbands into which an input image signal is split through a two-dimensional wavelet transform are designated by LL, HL, LH, and HH, where a lower-frequency component of each of the subbands is denoted by L and a higher-frequency component of each of the subbands is denoted by H, and the first character of each of the symbols denotes conversion in a horizontal direction and the second character of each of the symbols denotes conversion in a vertical scanning direction. A wavelet transform is recursively performed on a lower-frequency component (i.e., an LL component) in both the horizontal and vertical directions. The number of times that each wavelet transform is performed recursively is referred to as a decomposition level, and the number shown in front of each of LL, HL, LH, and HH in FIG. 1(b) denotes a decomposition level. In other words, in a case where the number of times that the wavelet transform is decomposed is 2, the decomposition level of the minimum resolution component is 2 and the decomposition level of the maximum resolution components HL, LH, and HH is 1 contrarily.

Next, the wavelet transform coefficient in each subband is quantized with a quantization step size which is set in advance for each subband.

Then, after the quantized wavelet transform coefficient in each subband is divided into a plurality of regions each of which has a fixed size and each of which is referred to as a code block, the plurality of code blocks each of which consists of multi-value data are converted into a plurality of binary bitplanes each of which is then classified into three types of coding passes: a Significant Propagation Decoding Pass, a Magnitude Refinement Pass, and a Cleanup Pass.

Context modeling is performed on a binary signal outputted from each of the three coding passes, and entropy coding is then performed on the binary signal.

In parallel to the entropy coding processing, the code amount and coding distortion in each of the code blocks are calculated for each coding pass.

Finally, a rate control process of adjusting the code amount to below a target code size is carried out while the degradation in the image quality (i.e., the coding distortion) is minimized using the Lagrange multiplier method. The rate control method is not standardized, and an arbitrary method can be used as the rate control method according to applications. Hereinafter, the outline of the workings of a rate control unit which is disclosed, as reference information, in the recommendation (ISO/ITU 15444-1:2000) J.14.3 will be explained.

According to this method, when in each code block i, a truncation point is shown by ni, the amount of codes including up to a code at the truncation point is shown by R(i,ni), and the coding distortion is shown by D(i,ni), the rate control parameter λ is adjusted using the Lagrange multiplier method so that the total code amount Rsum in the entire screen which is generated by the truncation point ni which maximizes the following equation falls within the limit of the target code amount Rmax.

Σ(R(i,ni)−λD(i,ni))

Here, the coding distortion D shows how much the mean square error of the reproduced image decreases when codes including up to a code associated with a certain coding pass are transmitted as compared with a case where no coded data are transmitted. Strictly speaking, the coding distortion D indicates the amount of decrease in the coding distortion. Therefore, the coding distortion D is 0 before the input data is coded, and the coding distortion D becomes equal to the mean square error after the last bitplane of the input data is coded.

FIG. 2 is a diagram for explaining derivation of an optimal coding pass using a prior art technique. Finding out the truncation point which maximizes the above-mentioned equation is equivalent to representing a relationship between the code amount R of each code block and the coding distortion D of each code block with a graph (referred to as an RD curve from here on), and finding out a point at which the slope of the tangent of the RD curve becomes equal to the inverse λ⁻¹ of a rate control parameter λ, as shown in FIG. 2. In FIG. 2, for two code blocks c1 and c2, truncation points at which the slope of the tangent is equal to the inverse λ⁻¹ of the rate control parameter λ are shown by ncl and nc2, respectively, and the amounts of codes including up to codes at the truncation points are shown by R(c1,nc1) and R(c2,nc2), respectively. Such code amounts R is summed for all the code blocks, and the sum of their code amounts is then compared with Rmax.

When this comparison is considered for each code block, the truncation point ni which maximizes (R(i,ni)−λD(i,ni)) needs to be found out as follows:

Set ni=0
For k=1, 2, 3,

### Set ΔR(i,k)=R(i,k)−R(i,ni) and

ΔD(i,k)=D(i,k)−D(i,ni)

### If (ΔD(i,k)/ΔR(i,k))>λ⁻¹)

then set ni=k

where k is a variable indicating the truncation point ni.

However, according to this algorithm, if the above-mentioned processing is not performed for a number of rate control parameters λ, the truncation point ni cannot be acquired. Then, the slope S(i,k)=ΔD(i,k)/ΔR(i,k) of the RD curve is corrected for in advance so that it monotonously decreases with respect to k. Specifically, a correcting process is carried out as follows:

(1) set Ni={n} (i.e. the set of all truncation point)
(2) Set p=0
(3) For k=1, 2, 3, 4, . . . , kmax

If k belongs to Ni
Set ΔR(i,k)=R(i,k)−R(i,p),
   and ΔD(i,k)=D(i,k)−D(i,p)
Set S(i,k)=ΔD(i,k)/ΔR(i,k)

If p#0 and S(i,k)>S(i,p)
then remove p from Ni, and go to step (2)

Otherwise, set p=k

where p is a variable indicating the truncation point ni.

As a result of this processing, the optimization of the truncation point for the given rate control parameter λ can be established by selecting a maximum k in Ni which satisfies the following inequality: S(i,k)>λ⁻¹.

FIG. 3 is a flow chart showing a process of correcting for the monotonous phenomenon of the slope of the RD curve in the prior art technology. The monotonous phenomenon correction processing in the above-mentioned steps (1) to (3) is summarized in the flow chart shown in FIG. 3. In FIG. 3, indicating each code block is omitted. Step ST13 of FIG. 3 corresponds to “If k belongs to Ni” of the above-mentioned step (3), and step ST16 of FIG. 3 corresponds to “remove p from ni” of the above-mentioned step (3), i.e., a process of removing p out of a candidate Ni for the truncation point. Thus, in FIG. 3, similar processing is implemented using a flag (flag) showing true or false for the truncation point.

When the derivation of these pieces of information is completed for all the code blocks, coded data having a code amount which is equal to the target code amount Rmax is created. Specifically, a rate control parameter λ which gives a maximum total code amount Rsum that satisfies the following inequality: Rsum<=Rmax is found out for the total code amount Rsum of the entire screen with respect to a certain rate control parameter λ. The total code amount Rsum with respect to a certain rate control parameter λ can be acquired only after the truncation point is uniquely determined for each code block, and the sum of coded data including up to coded data at the truncation point is calculated. Then, in order to find out a rate control parameter λ which gives the maximum total code amount Rsum that satisfies the following inequality: Rsum<=Rmax, usually the total code amount Rsum is calculated for each of a plurality of candidates for the rate control parameter λ, and a rate control parameter λ which provides a total code amount Rsum which is close to the desired value is calculated through convergence operation. When such a rate control parameter λ can be found out, coded data including up to coded data at the truncation point corresponding to the rate control parameter λ are collected from all the code blocks and the number of coding passes in each code block is added, as additional information, to the collected coded data, so that final coded data are formed. In this way, coded data which minimizes the coding distortion D when the target code amount Rmax is preset can be produced.

The JPEG2000 International Standards mentioned above can be obtained through a standards committee, such as ISO or ITU-T. The latest information about JPEG2000 can be also obtained by referring to http://www.jpeg.org.

In the prior art image coding apparatus constructed as mentioned above, when finding out the truncation point using the above-mentioned rate controlling method, coding passes including a coding pass which is to be coded after the truncation point at which no coded data are actually outputted, usually, all coding passes must be entropy-coded in advance, and algebraic coding which needs arithmetic operations for every 1 bit is used for the entropy coding which complies with JPEG2000 and therefore the amount of arithmetic operation of the algebraic coding has a significant impact on the whole throughput. Therefore, a problem with the prior art image coding apparatus is that the entropy coding of a coding pass which is to be coded after the truncation point causes increase in the throughput and hence increase in the amount of arithmetic operation required for the coding, and this results in the occurrence of a delay in the processing time.

Furthermore, the total code amount Rsum with respect to a certain rate control parameter λ can be acquired only after the truncation point is uniquely determined for each code block, and the sum of coded data including up to coded data at the truncation point is calculated. Another problem is therefore that since in order to find out a rate control parameter λ which gives the maximum total code amount Rsum that satisfies the following inequality: Rsum<=Rmax, the total code amount Rsum is calculated for each of a plurality of candidates for the rate control parameter λ, and a rate control parameter λ which provides a total code amount Rsum which is close to the desired value is repeatedly found out through convergence operation, the amount of arithmetic operation required for rate control is increased.

The present invention is made in order to solve the above-mentioned problems, and it is therefore an object of the present invention to provide an image coding apparatus which can reduce the amount of arithmetic operation required for entropy coding and rate control.

### DISCLOSURE OF THE INVENTION

In accordance with the present invention, there is provided an image coding apparatus including: an entropy coding means for dividing a quantized wavelet transform coefficient for each of subbands, into which an input data is wavelet-transformed and is then split, into code blocks, for converting each of the code blocks into bit planes and dividing the bit planes into coding passes, and for coding the input data for each of the coding passes and outputting coded data; a code memory for storing the coded data which is coded for each of the coding passes; a rate control information extraction means for determining which up to a coding pass in which code block should be coded by the above-mentioned entropy coding means on a basis of either a total code amount indicating a sum of code amounts of the code blocks or a sum of coding distortions of the code blocks, the slope of an RD curve calculated from both the distortion difference between a coding distortion which occurs at a time of coding each coding pass and a coding distortion which occurs at a time of coding a preceding coding pass, and a number of output bytes of a code amount of each coding pass, and an inverse of one of a plurality of given rate control parameters which are listed in order of decreasing monotonously, and for outputting an end-of-coding pass in which the coding is ended; and a coded data extraction means for reading coded data including up to coded data corresponding to a code pass specified by the end-of-coding pass outputted from the above-mentioned rate control information extraction means from the above-mentioned code memory, for adding a number of coding passes in each code block to the coded data read out of the above-mentioned code memory, and for outputting them as a code stream.

Therefore, the present invention offers an advantage of being able to reduce the amount of arithmetic operation required for entropy coding and rate control.

### BRIEF DESCRIPTION OF THE FIGURES

FIG. 1 is a diagram showing a wavelet transform in a prior art technology;

FIG. 2 is a diagram for explaining a derivation of an optimal coding pass in the prior art technology;

FIG. 3 is a flow chart showing a process of correcting for the monotonous phenomenon of the slope of an RD curve in the prior art technology;

FIG. 4 is a block diagram showing the structure of an image coding apparatus in accordance with embodiment 1 of the present invention;

FIG. 5 is a block diagram showing the internal structure of a rate control information extraction means of the image coding apparatus in accordance with embodiment 1 of the present invention;

FIG. 6 is a diagram showing subbands which are generated when a wavelet transform means of the image coding apparatus in accordance with embodiment 1 of the present invention carries out a wavelet transform with a decomposition level of 2;

FIG. 7 is a diagram for explaining bitplanes in the image coding apparatus in accordance with embodiment 1 of the present invention;

FIG. 8 is a diagram for explaining decomposition of the bitplanes into coding passes in the image coding apparatus in accordance with embodiment 1 of the present invention;

FIG. 9 is a flowchart showing a flow of processing carried out by the image coding apparatus in accordance with embodiment 1 of the present invention;

FIG. 10 is a diagram showing a sequence of coding of the coding passes in the image coding apparatus in accordance with embodiment 1 of the present invention;

FIG. 11 is a block diagram showing the internal structure of a rate control information extraction means of an image coding apparatus in accordance with embodiment 2 of the present invention;

FIG. 12 is a diagram showing the data structure of an RD table stored in a rate distortion memory of the image coding apparatus in accordance with embodiment 2 of the present invention;

FIG. 13 is a flow chart showing a flow of processing carried out by the image coding apparatus in accordance with embodiment 2 of the present invention;

FIG. 14 is a diagram showing correction of the slope of an RD curve in the image coding apparatus in accordance with embodiment 2 of the present invention;

FIG. 15 is a block diagram showing the internal structure of a rate control information extraction means of an image coding apparatus in accordance with embodiment 3 of the present invention;

FIG. 16 is a diagram showing the data structure of an RD table stored in a rate distortion memory of the image coding apparatus in accordance with embodiment 3 of the present invention; and

FIG. 17 is a flow chart showing a flow of processing carried out by the image coding apparatus in accordance with embodiment 3 of the present invention;

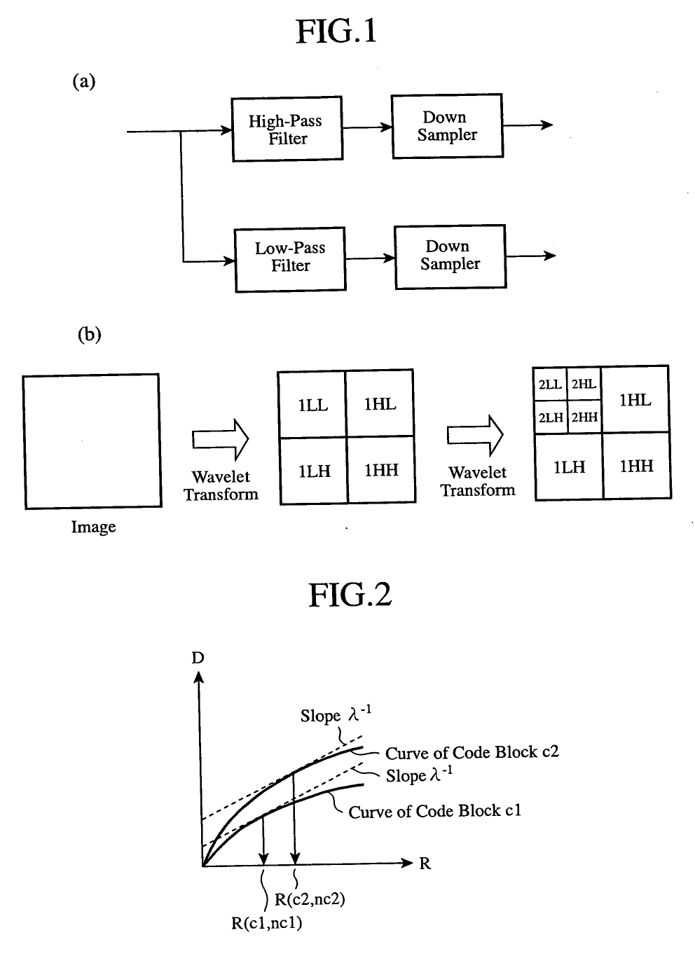

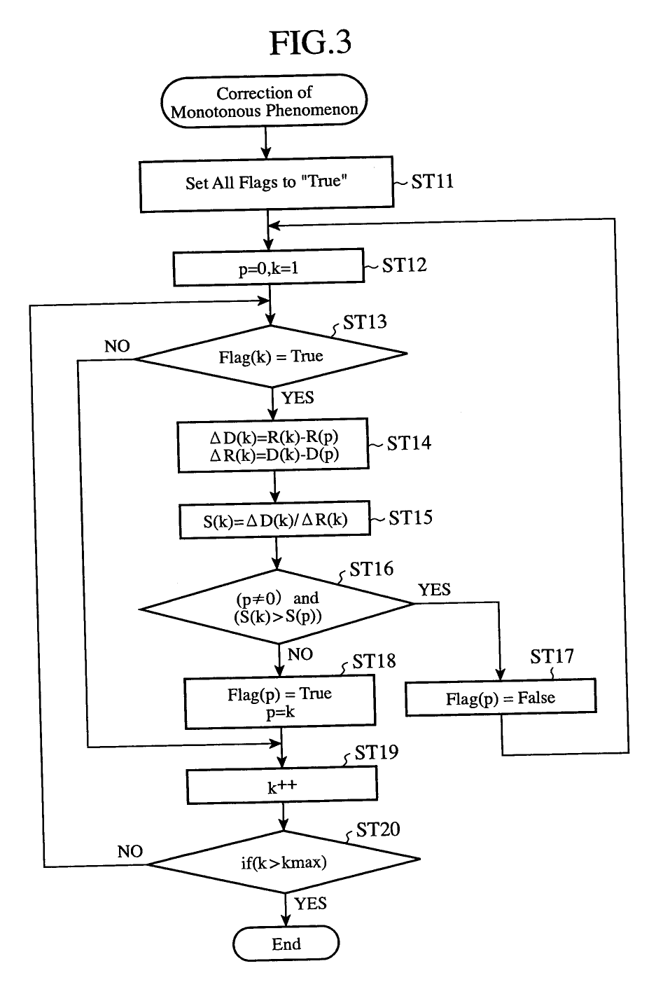

### PREFERRED EMBODIMENTS OF THE INVENTION

Hereafter, in order to explain this invention in greater detail, the preferred embodiments of the present invention will be described with reference to the accompanying drawings.

### Embodiment 1

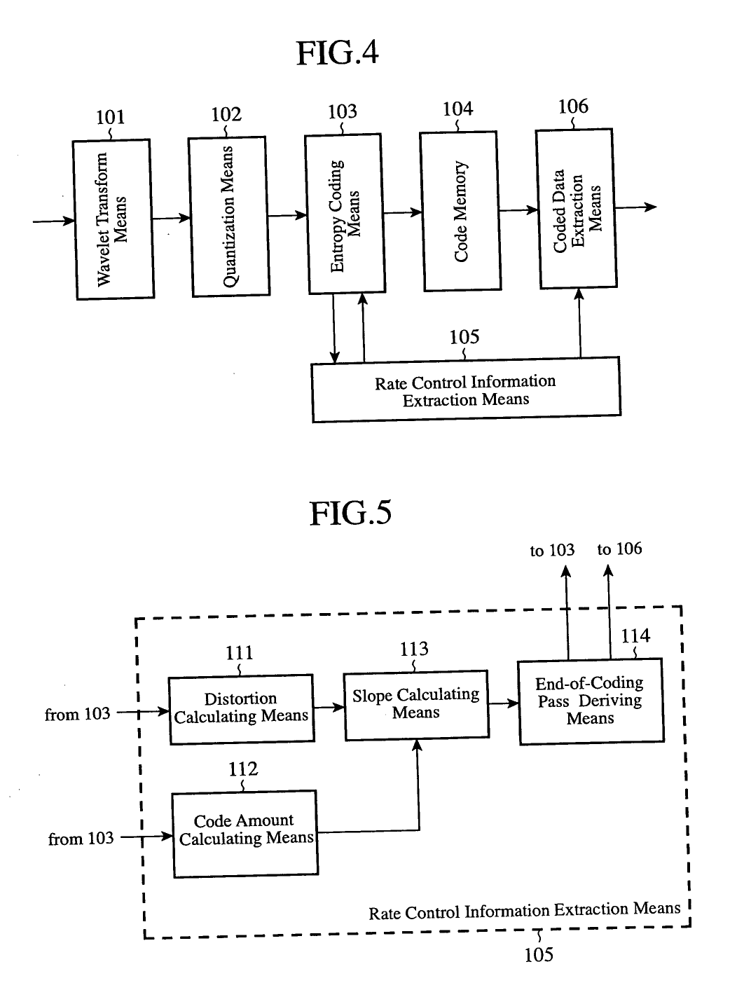

FIG. 4 is a block diagram showing the structure of an image coding apparatus in accordance with embodiment 1 of the present invention. This image coding apparatus is provided with a wavelet transform means 101, a quantization means 102, an entropy coding means 103, a code memory 104, a rate control information extraction means 105, and a coded data extraction means 106.

In FIG. 4, the wavelet transform means 101 performs a two-dimensional wavelet transform on an input image signal recursively so as to split the input image signal into subbands, and generates a wavelet transform coefficient for each of the subbands. The quantization means 102 carries out a process of quantizing the wavelet transform coefficient generated by the wavelet transform means 101 with a quantization step size which is set in advance. The entropy coding means 103 divides the quantized wavelet transform coefficient into code blocks, converts each of the code blocks into bitplanes, classifies the bitplanes into coding passes, entropy-codes the input data for each of the coding passes, and outputs the coded data. The code memory 104 stores the coded data which is entropy-coded for each coding pass temporarily therein. The rate control information extraction means 105 determines which up to a coding pass in which code block should be coded by the entropy coding means 103 on the basis of a total code amount indicating the sum of the code amounts R of the code blocks, the slope S of the RD curve calculated from both the distortion difference ΔD between a coding distortion D which occurs at a time of coding each coding pass and a coding distortion D which occurs at a time of coding an immediately-preceding coding pass, and the number of output bytes ΔR of the code amount R of each coding pass, and the inverse λ⁻¹ of one of a plurality of given rate control parameters which are listed in order of monotonously decreasing, and outputs an end-of-coding pass at which the coding will be ended. The coded data extraction means 106 reads coded data including coded data corresponding to up to a coding pass which is determined by the end-of-coding pass outputted from the rate control information extraction means 105 from the code memory 104, adds the number of coding passes in each code block to the read coded data, and outputs them as a code stream.

FIG. 5 is a block diagram showing the internal structure of the rate control information extraction means 105. This rate control information extraction means 105 is provided with a distortion calculating means 111, a code amount calculating means 112, a slope calculating means 113, and an end-of-coding pass deriving means 114.

In FIG. 5, the distortion calculating means 111 calculates the difference ΔD between the coding distortion D of each coding pass from the entropy coding means 103 and the coding distortion D of an immediately-preceding coding pass from the entropy coding means 103. The code amount calculating means 112 then counts the number of output bytes ΔR of the code amount R for each coding pass from the entropy coding means 103. The slope calculating means 113 calculates the slope S of the RD curve from the distortion difference ΔD calculated by the distortion calculating means 111 and the number of output bytes ΔR counted by the code amount calculating means 112. The end-of-coding pass deriving means 114 determines whether to continue to perform the coding for each code block so as to derive an end-of-coding pass on the basis of the total code amount Rsum in the entire screen which indicates the sum of the code amounts R of the plurality of code blocks, the slope S calculated by the slope calculating means 113, and the inverse λ⁻¹ of a given rate control parameter, and outputs both information indicating that the coding will be ended and the end-of-coding pass.

Next, the operation of the image coding apparatus in accordance with this embodiment of the present invention will be explained.

First, in FIG. 4, an image signal from an image input device (not shown), such as an image scanner, a digital camera, a network, or a storage medium, is inputted to the wavelet transform means 101. The wavelet transform means 101 performs one-dimensional wavelet transforms in both a vertical direction and a horizontal direction on the inputted image signal in two dimensions so as to split the image signal into subbands and to generate a wavelet transform coefficient for each of the subbands. In this case, each one-dimensional wavelet transform is implemented by a filter bank including a low-pass filter and a high-pass filter.

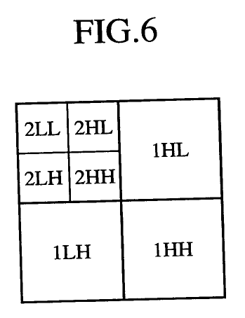

FIG. 6 is a diagram showing the subbands into which the input image signal is split when the wavelet transform means 101 carries out the wavelet transform processing so that the decomposition level reaches 2, and shows an example in which the two-dimensional wavelet transform is recursively performed on the input image signal twice. In FIG. 6, the leading number in each symbol denotes the decomposition level of a corresponding subband, and the two subsequent alphabetic characters each of which is L or H denote filters associated with the horizontal and vertical directions, respectively. Furthermore, L denotes a result obtained by a low-pass filter, and H denotes a result obtained by a high-pass filter. The performance of the two-dimensional wavelet transform “recursively” twice means that the subbands 1LL, 1HL, 1LH, and 1HH are generated first through the first-time wavelet transform, and the second-time wavelet transform is then performed on the subband 1LL and, as a result, the subbands 2LL, 2HL, 2LH, and 2HH are generated.

The quantization means 102 quantizes the wavelet transform coefficient generated by the wavelet transform means 101 with a quantization step size which is set for each subband.

The entropy coding means 103 divides the wavelet transform coefficient generated for each subband into a plurality of rectangular areas each having a fixed size, which are referred to as code blocks, and, after that, converts the plurality of code blocks each of which consists of multi-value data into a plurality of binary bitplanes. Typically, the plurality of code blocks have a block size of 64×64 or 32×32.

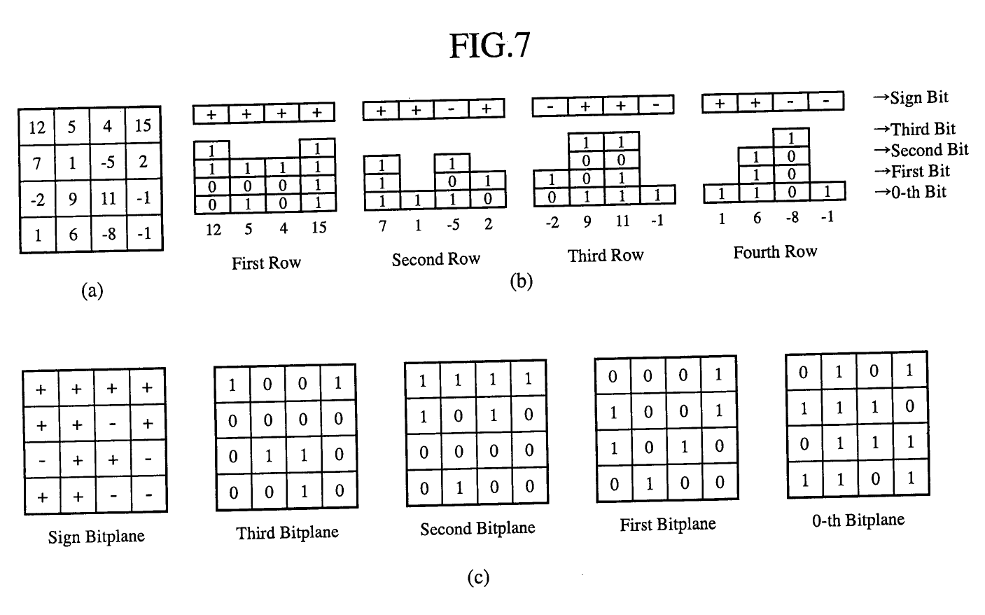

FIG. 7 is a diagram explaining the plurality of bitplanes. Hereafter, the decomposition of the plurality of code blocks into the plurality of bitplanes will be explained in detail with reference to FIG. 7. FIG. 7(a) shows an example of 4×4 code blocks. Each of four data in each row of the 4×4 code blocks of FIG. 7(a) is converted into a 1-bit signal showing the sign thereof and a 4-bit binary value indicating the absolute value thereof and running in a column, as shown FIG. 7(b). Next, bits specified by each same bit number shown in FIG. 7(b) are collected to generate a plurality of bitplanes shown in FIG. 7(c). In this case, when the least significant bit (LSB: Least Significant Bit) of each data is defined as the 0-th bit and the most significant bit (MSB: Most Significant Bit) of each data is defined as the third bit, all collected bits associated with the 0-th bit are defined as a 0-th bitplane, all collected bits associated with the first bit are defined as a first bitplane, all collected bits associated with the second bit are defined as a second bitplane, and all collected bits associated with the third bit are defined as a third bitplane. In addition, a code bitplane is generated as an array of the bits each of which shows the sign of the corresponding code block.

The entropy coding means 103 then classifies each bit in each of the plurality of bitplanes into any one of the following three types of coding passes: a significance propagation decoding pass (Significance Propagation Decoding Pass), a magnitude refinement pass (Magnitude Refinement Pass), and a cleanup pass (Cleanup Pass) according to the context of each bit.

Next, the entropy coding means 103 carries out context modeling to carry out entropy coding using algebraic coding for each coding pass. However, neither context modeling nor coding is performed on the bitplane associated with the MSB if all the bits of the bitplane are set to 0, and neither context modeling nor coding is performed on any lower bitplane in which all the bits are set to 0 as long as all the bits are set to 0 in all bitplanes higher than the lower bitplane. Then, if a bitplane in which a bit of 1 appears is the first one when numbering it from the bitplane associated with the MSB, all the bits in the bitplane are classified into a cleanup pass. In other bitplanes, each bit is classified into any one of the three types of coding passes, as mentioned above.

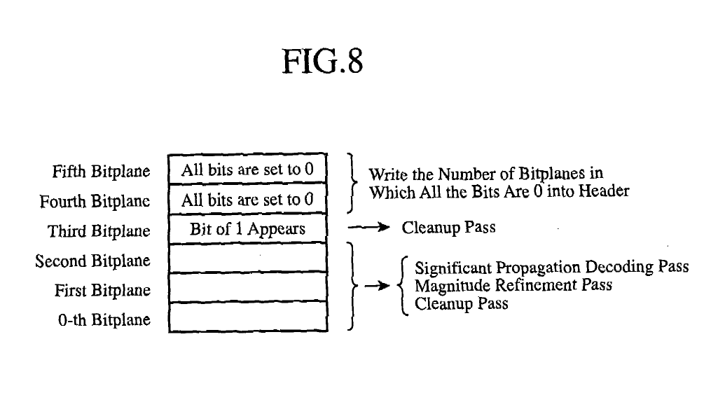

FIG. 8 is a diagram for explaining the decomposition of the plurality of bitplanes into the plurality of coding passes, and shows an example in a case where the number of bitplanes into which the plurality of code blocks are decomposed is 6 and the number of effective bitplanes in which one or more bits of 1 appear is 4.

After the contest modeling is completed, the entropy coding means 103 carries out entropy coding using algebraic coding, and stores the entropy-coded data in the code memory 104.

In parallel to the processing carried out by the entropy coding means 103, every time when the coding of a certain coding pass is completed, the distortion calculating means 111 of the rate control information extraction means 105 calculates the difference ΔD between the coding distortion D of the certain coding pass and the coding distortion D of an immediately-preceding coding pass for each code block from the entropy coding means 103. The coding distortion D shows how much the mean square error of the reproduced image decreases when codes including up to a code associated with a certain coding pass are transmitted as compared with a case where no coded data are transmitted. Strictly speaking, the coding distortion D indicates the amount of decrease in the coding distortion. Therefore, the coding distortion D becomes equal to the mean square error when the distortion difference ΔD is accumulated until the last bitplane is coded.

Simultaneously, every time when the coding of a certain coding pass is completed, the code amount calculating means 112 of the rate control information extraction means 105 counts the number of output bytes ΔR of the code amount R in the coding pass for each code block from the entropy coding means 103. The slope calculating means 113 then calculates the slope S of the RD curve in the current coding pass by dividing the distortion difference ΔD which is calculated by the distortion calculating means 111 by the number of output bytes ΔR in the current coding pass which is counted by the code amount calculating means 112.

The end-of-coding pass deriving means 114 determines whether to continue to perform the coding currently being done on the current code block on up to a further coding pass on the basis of the total code amount Rsum in the entire screen which indicates the sum of the code amounts R of the plurality of code blocks, the slope S calculated by the slope calculating means 113, and the inverse λ⁻¹ of the given rate control parameter, and outputs the determination result to the entropy coding means 103. When the determination result indicates that the coding currently being done on the current code block should be continued, the entropy coding means 103 codes the next coding pass, the distortion calculating means 111 calculates the distortion difference ΔD between the coding distortion D of the coding pass and the coding distortion D of the immediately-preceding coding pass, the code amount calculating means 112 counts the number of output bytes ΔR of the code amount R in the coding pass, the slope calculating means 113 calculates the slope S of the RD curve in the coding pass, and the end-of-coding pass deriving means 114 determines again whether to continue to perform the coding currently being done on the current code block on up to a further coding pass on the basis of the total code amount Rsum in the entire screen which indicates the sum of the code amounts R of the plurality of code blocks, the slope S calculated by the slope calculating means 113, and the inverse λ⁻¹ of the given rate control parameter. On the other hand, when determining that the coding currently being done on the current code block should not be continued, the end-of-coding pass deriving means outputs information an end of the coding to the entropy coding means 103, and outputs an end-of-coding pass indicating the end of the coding to the coded data extraction means 106.

The entropy coding means 103 receives the information about the end of the coding from the end-of-coding pass deriving means 114, and does not code any further coding pass for the current code block.

The coded data extraction means 106 reads coded data including coded data associated with up to a coding pass which is determined by the end-of-coding pass in each code block from the code memory 104, adds the number of coding passes in each code block, as additional information, to the read coded data, arranges them in a specified order, and outputs them as a code stream after adding predetermined header information to them.

Hereafter, the details of the processing carried out by the rate control information extraction means 105 will be explained. The rate control information extraction means prepares a plurality of candidates for the rate control parameter λ in advance, and makes the entropy coding means perform the coding on up to a coding pass which satisfies a certain rate control parameter λ for all the code blocks. At that time, the rate control information extraction means determines whether the total code amount Rsum for all the code blocks reaches a target code amount Rmax, and, when determining that the total code amount Rsum reaches the target code amount Rmax, makes the entropy coding means end the coding. On the other hand, when determining that the total code amount Rsum does not reach the target code amount Rmax, the rate control information extraction means selects the next candidate for the rate control parameter λ, and makes the entropy coding means perform the coding again until all the code blocks satisfy the rate control parameter λ. Thus, the rate control information extraction means carries out the process of selecting the next candidate for the rate control parameter λ, and causing the entropy coding means to perform the coding until the total code amount Rsum reaches the target code amount Rmax. The rate control information extraction means determines whether all the code blocks satisfy a rate control parameter λ by calculating the slope S of the RD curve at the time when the coding of each coding pass is completed, and then determining whether the slope S becomes less than the inverse λ⁻¹ of the rate control parameter.

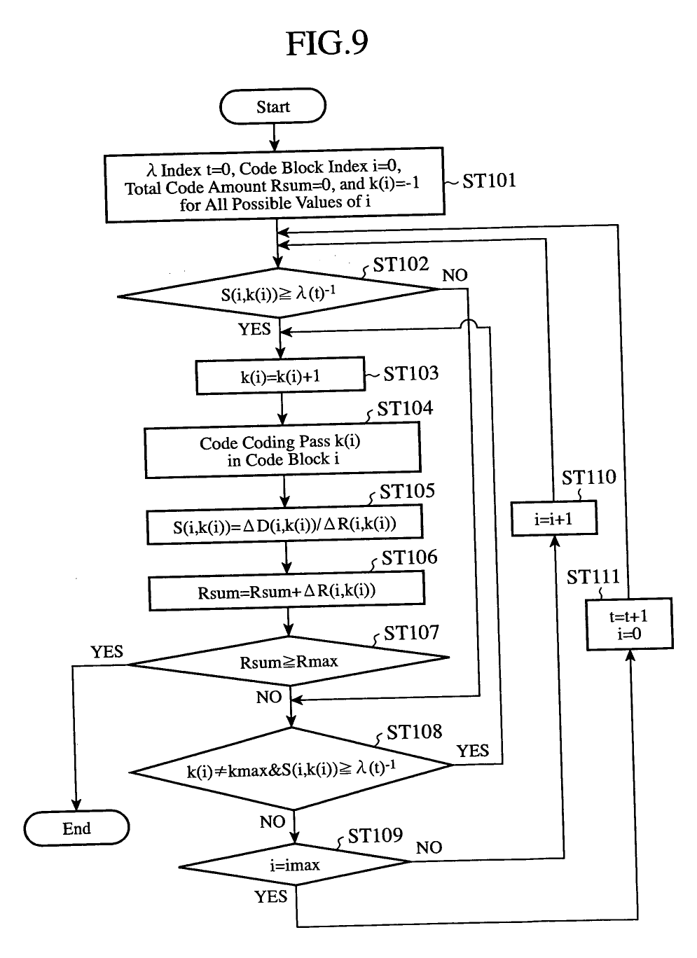

FIG. 9 is a flow chart showing a flow of the processing carried out by the image coding apparatus in accordance with embodiment 1 of the present invention. Hereafter, a method of determining coding passes which should be coded will be explained with reference to FIG. 9. Candidates for the rate control parameter λ(t) are set as follows:

λ(t)={λ(0), λ(1), λ(2), . . . , λ(tmax)}

The values of the candidates for the rate control parameter λ(t) are set so as to increase monotonously, i.e., so that the following inequality: λ(t)<λ(t+1) is established. That is, the inverses λ(t)⁻¹ of the candidates for the rate control parameter λ(t) are set so as to decrease monotonously.

In step ST101, the entropy coding means 103 makes initial settings as follows. The entropy coding means 103 sets the initial value of the index t of the rate control parameter λ to t=0 (t=0 to tmax), sets the index i of the code block to i=0 (i=0 to imax), sets the counter of the total code amount to Rsum=0, and sets a variable k(i) which stores a number specifying a coding pass for each code block to −1 for each of all the code blocks (the index of the next coding pass is 0 when the zero bitplane is skipped, k(i)=−1 to kmax, and the initial value of the variable is set to k(i)=−1 to suit the convenience of the counter used for the variable).

Although no memory is shown in the rate control information extraction means 105 in the figure, the variable k(i) is a variable for storing a number specifying a coding pass to be coded for each code block, and the index t of the rate control parameter λ, the index i of the code block, and the counter Rsum of the total code amount are variables which are common to all the code blocks.

In step ST102, the end-of-coding pass deriving means 114 determines if the following inequality: S(i, k(i))>=λ(t)⁻¹ is established. Since this step ST102 is the process of determining whether or not it is necessary to code a new coding pass when the next candidate for the rate control parameter λ(t) is selected, the end-of-coding pass deriving means initially sets S(i,−1) to a sufficiently large value so that S(i,k(i))>=λ(t)⁻¹ holds absolutely. In step ST103, the entropy coding means 103 increments the variable k(i) which stores a number specifying a coding pass to be coded for each code block so as to prepare for the coding of the first coding pass.

In step ST104, the entropy coding means 103 codes the coding pass to be coded, which is specified by k(i), in the code block i. In step ST105, for the current coding code block i, the distortion calculating means 111 calculates the distortion difference ΔD(i,k(i)) between the coding distortion D of the current coding pass k and that of the immediately-preceding coding pass k−1, the code amount calculating means 112 calculates the number of output bytes ΔR(i,k(i)) of the code amount R in the current coding pass, and the slope calculating means 113 calculates the slope S of the RD curve in the current coding pass.

S(i,k(i))=ΔD(i,k(i))/ΔR(i,k(i))

where for the first coding pass 0, the slope S is set to a sufficiently large value.

In step ST106, the end-of-coding pass deriving means 114 adds the number of output bytes ΔR(i,k(i)) of the code amount R which occurs in the current coding pass to the counter Rsum of the total code amount. In step ST107, the end-of-coding pass deriving means 114 then determines whether the counter Rsum of the total code amount reaches a target code amount Rmax, and, when determining that the counter Rsum of the total code amount reaches the target code amount Rmax, outputs information about an end of the coding for each code block to the entropy coding means 103, and outputs, as an end-of-coding pass, the coding pass index k(i) indicating which up to a coding pass has been coded for each code block, to the coded data extraction means 106.

When, in step ST107, determining that the counter Rsum of the total code amount does not reach the target code amount Rmax, the end-of-coding pass deriving means 114, in step ST108, determines whether or not the slope S(i,k(i)) in the current coding pass is equal to or larger than λ(t)⁻¹, and, when determining that the slope S(i,k(i)) is equal to or larger than λ(t)⁻¹, notifies the entropy coding means 103 that the slope S(i,k(i)) is equal to or larger than λ(t)⁻¹, and returns to step ST103 in which the entropy coding means 103 further codes the next coding pass. On the other hand, when determining that the slope S(i,k(i)) is smaller than λ(t)⁻¹, the end-of-coding pass deriving means notifies the entropy coding means 103 that the slope S(i,k(i)) is smaller than λ(t)⁻¹, and the entropy coding means 103 temporarily stores coded data about the coded coding pass in the code memory 104, and aborts the coding of the current code block. In step ST109, when the code block index i is not equal to imax, the entropy coding means 103, in step ST110, increments the code block index i by 1 and then shifts the processing to the coding of the next code block.

The image coding apparatus repeats steps ST104 to ST108 similarly for the next code block, and continues to perform the coding for the next code block until the slope S(i,k(i)) becomes smaller than λ(t)⁻¹. After carrying out this process for all the code blocks in step ST109, the entropy coding means, in step ST111, increments the index t of the rate control parameter λ by 1, and sets the rate control parameter λ to the next one of the candidates which are listed in order of monotonously increasing. The entropy coding means also carries out the coding for all the code blocks until the slope S(i,k(i)) becomes smaller than λ(t)⁻¹. There can be a case where even if the next candidate for the rate control parameter λ(t) is selected, S(i,k(i))<λ(t)⁻¹, that is, the inverse λ(t)⁻¹ of the next candidate for the rate control parameter is larger than the slope S in the already-coded coding pass. In such a case, since the next coding pass is not coded, the end-of-coding pass deriving means, in step ST102, determines that the inverse λ(t)⁻¹ of the next candidate for the rate control parameter is larger than the slope S(i,k(i)) in the already-coded coding pass, and skips the coding processing and shifts to step ST108.

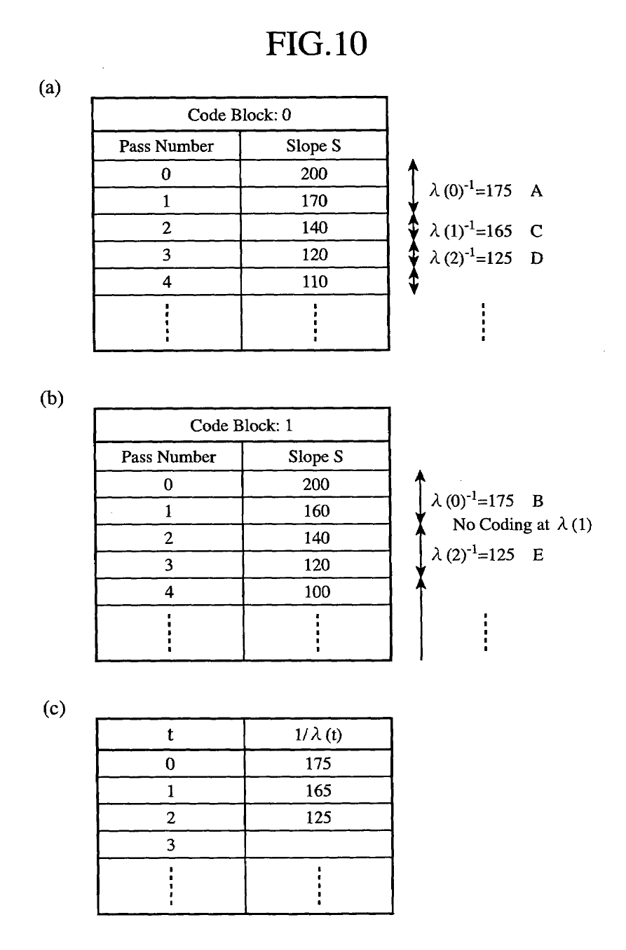

FIG. 10 is a diagram showing a sequence of the coding of coding passes. Coding passes corresponding to candidates λ(t) for the rate control parameter in a case where the total number of code blocks is 2 (imax=1), and a sequence in which they are processed will be explained with reference to FIG. 10. FIG. 10(a) shows the slope S in a coding pass specified by each pass number of a code block 0, FIG. 10(b) shows the slope S in a coding pass specified by each pass number of a code block 1, and FIG. 10(c) shows the inverses λ(t)⁻¹ of the preset candidates for the rate control parameter which are listed in order of monotonously decreasing.

First, in the code block 0, coding passes having pass numbers 0 and 1 are coded until the slope S satisfies the following inequality: S(k)<(0)⁻¹ (see A of FIG. 10(a)). At this time, unless the total code amount Rsum reaches the target code amount Rmax, the image coding apparatus shifts the target of the processing to the next code block 1, and then codes the coding passes having pass numbers 0 and 1 until the slope S similarly satisfies the following inequality: S(k)<λ(0)⁻¹ (see B of FIG. 10(b)).

At this time, unless the total code amount Rsum reaches the target code amount Rmax, the image coding apparatus sets the rate control parameter to the next value λ(1), performs the processing on the code blocks starting from the code block 0, and codes the coding pass having a pass number 2 of the code block 0 (see C of FIG. 10(a)). Next, in the code block 1, since the slope S=160 of the coding pass having a pass number 1 which has been coded immediately before is smaller than 1/λ(1)=165, the image coding apparatus does not carry out any coding processing.

After that, similarly, unless the total code amount Rsum reaches the target code amount Rmax, the image coding apparatus sets the rate control parameter to the next value λ(2), codes the coding pass having a pass number 3 of the code block 0 (see D of FIG. 10 (a)), and then codes the coding passes having pass numbers 2 and 3 of the code block 1 (see E of FIG. 10 (b)). The image coding apparatus thus carries out the above-mentioned processing until the total code amount Rsum reaches the target code amount Rmax.

In accordance with this embodiment 1, the image coding apparatus carries out the coding processing until the total code amount Rsum reaches the target code amount Rmax, as previously mentioned. As an alternative, the image coding apparatus can set a target coding distortion instead of the target code amount Rmax, and can carry out the coding processing until the sum of the coding distortions D of all code blocks in the entire screen reaches the target coding distortion.

As previously mentioned, the rate control information extraction means 105 according to this embodiment 1 calculates the slope S of the RD curve from both the distortion difference ΔD between the coding distortion D which occurs at the time of coding each coding pass and the coding distortion D which occurs at the time of coding an immediately-preceding coding pass, and the number of output bytes ΔR of the code amount R of each coding pass, and calculates either the total code amount Rsum indicating the sum of the code amounts R of all the code blocks or the sum of the coding distortions D of all the code blocks. When the total code amount Rsum reaches the target code amount Rmax, or when the sum of the coding distortions D of all the code blocks reaches the target coding distortion, the image decoding apparatus determines that it will end the coding processing and then ends the coding processing. On the other hand, unless the total code amount Rsum reaches the target code amount Rmax, or unless the sum of the coding distortions D reaches the target coding distortion, the image decoding apparatus makes the entropy coding unit code each coding pass in the current code block until the slope S becomes smaller than the inverse λ⁻¹ of the given rate control parameter, and, when the slope S becomes smaller than the inverse λ⁻¹ of the rate control parameter, makes the entropy coding unit code each coding pass in the next code block. After that, when completing the coding of each coding pass in all the code blocks, the image decoding apparatus uses the inverse λ⁻¹ of another rate control parameter, which is monotonously reduced from and is next to the inverse λ⁻¹ of the given rate control parameter, so as to determine which up to a coding pass in which code block should be coded.

As mentioned above, since the image coding apparatus according to this embodiment 1 performs the coding processing on only a coding pass which actually outputs coded results, the amount of arithmetic operation required for the entropy coding can be further reduced as compared with conventional methods of coding all the coding passes. In addition, since the image coding apparatus according to this embodiment 1 ends the coding processing when the total code amount reaches the target code amount, it does not need to carry out a convergence operation in order to make the total code amount reach the target code amount, and therefore the amount of arithmetic operation needed for rate control can be reduced.

Instead of transmitting the number of coding passes as additional information, both the coding side and a decoding side can estimate the amount of codes which are generated at the time of coding a coding pass to be coded and the amount of decrease in the distortion, and can also determine which up to a coding pass should be coded from the estimated amount of codes and amount of decrease in the distortion.

In contrast, in accordance with the present invention, the number of coding passes is transmitted for each code block, and the additional information about the number of coding passes makes up at most several percent of the total amount of information. This little overhead makes it possible to end the coding processing at substantially an optimal coding pass from the viewpoint of minimizing the coding distortion (the end-of-coding pass determined from the estimated values is not the optimal coding pass). Furthermore, in general, since the amount of arithmetic operation required to estimate the code amount and the amount of coding distortion is extremely large than that required to count the amount of actually-generated codes and the amount of coding distortion in accordance with the present invention, the increase in the amount of arithmetic operation results in increase in the amount of arithmetic operation needed for rate control.

From the above viewpoint, the rate control technique according to the present invention for transmitting the number of coding passes as additional information is effective at reducing the code amount in the coding method of minimizing the coding distortion.

### Embodiment 2

In above-mentioned embodiment 1, the explanation is made on the assumption that the slope S of the RD curve decreases monotonously as the image coding apparatus carries out the coding processing. However, in some cases, the slope S may not decrease monotonously, and the image coding apparatus may select an end-of-coding pass which is not optimal in a sense of minimizing the square error. In contrast, in accordance with this embodiment 2, in a case where the slope S does not decrease monotonously, every time when advancing up to a certain coding pass to code this coding pass, and calculating the slope S, an image coding apparatus additionally carries out a process of correcting for the slope S so that it becomes smaller than the slope S of any already-coded coding pass in order to determine an end-of-coding pass which is closer to an optimal one.

A block diagram showing the structure of the image coding apparatus in accordance with embodiment 2 of the present invention is the same as FIG. 4 of above-mentioned embodiment 1.

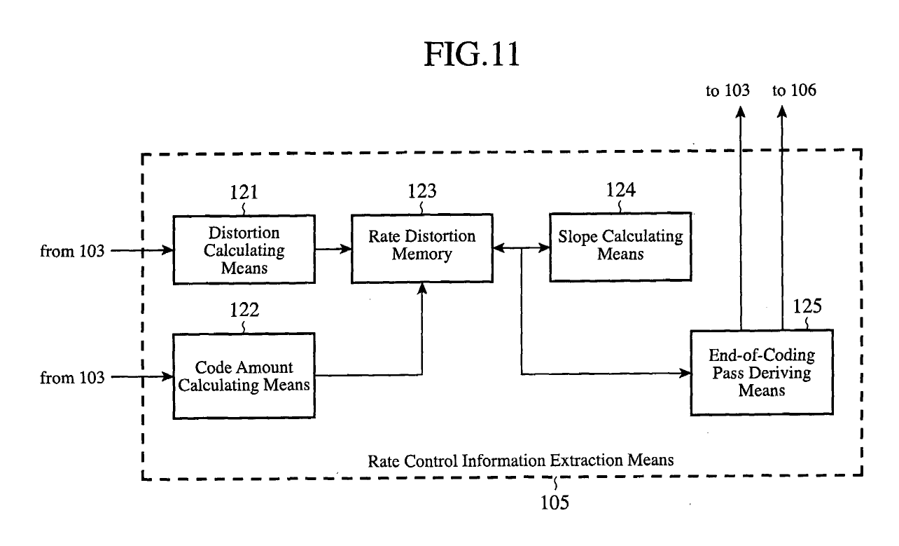

FIG. 11 is a block diagram showing the internal structure of a rate control information extraction means 105 of the image coding apparatus in accordance with embodiment 2 of the present invention. This rate control information extraction means 105 is provided with a distortion calculating means 121, a code amount calculating means 122, a rate distortion memory 123, a slope calculating means 124, and an end-of-coding pass deriving means 125.

In FIG. 11, the distortion calculating means 121 calculates the difference ΔD between the coding distortion D of each coding pass from an entropy coding means 103, and the coding distortion D of an immediately-preceding coding pass from the entropy coding means 103, and also calculates an accumulated coding distortion D by accumulating the distortion difference ΔD. The code amount calculating means 122 counts the number of output bytes ΔR of the code amount R of each coding pass from the entropy coding means 103, and also counts an accumulated code amount R by accumulating the number of output bytes ΔR. The rate distortion memory 123 stores the accumulated coding distortion D which is obtained by accumulating the distortion difference ΔD, the accumulated code amount R which is obtained by accumulating the number of output bytes ΔR, the slope S of the RD curve, etc. for each coding pass. The slope calculating means 124 then determines the distortion difference ΔD from the accumulated coding distortion D of each coding pass stored in the rate distortion memory 123, determines the number of output bytes ΔR from the accumulated code amount R of each coding pass stored in the rate distortion memory 123, and calculates the slope S of the RD curve from the determined distortion difference ΔD and number of output bytes ΔR. The end-of-coding pass deriving means 125 then determines the ratio of the distortion difference ΔD between the coding distortion D of the current coding pass and that of a preceding coding pass which has been coded before the current coding pass is coded and whose RD curve with the current coding pass has a smaller slope S than that of the RD curve associated with preceding coding passes, to the number of output bytes ΔR, so as to define the ratio as the corrected slope S of the current coding pass, determines whether to continue to perform the coding for each code block so as to derive an end-of-coding pass on the basis of the total code amount Rsum in the entire screen which indicates the sum of the code amounts R of the plurality of code blocks, the corrected slope S of the current coding pass, and the inverse λ⁻¹ of a given rate control parameter, and outputs both information indicating an end of the coding, and the end-of-coding pass.

Next, the operation of the image coding apparatus in accordance with this embodiment of the present invention will be explained.

Processings other than processing carried out by the rate control information extraction means 105 are the same as those as explained in above-mentioned embodiment 1, and therefore only the processing carried out by the rate control information extraction means 105 will be explained hereafter.

In parallel to the processing carried out by the entropy coding means 103, every time when the coding of a certain coding pass is completed, the distortion calculating means 121 of the rate control information extraction means 105 calculates the difference ΔD between the coding distortion D of the certain coding pass and the coding distortion D of an immediately-preceding coding pass for each code block from the entropy coding means 103, and also calculates an accumulated coding distortion D=D+ΔD by accumulating the distortion difference ΔD. The coding distortion D shows how much the mean square error of the reproduced image decreases when codes including up to a code associated with a certain coding pass are transmitted as compared with a case where no coded data are transmitted. Strictly speaking, the coding distortion D indicates the amount of decrease in the coding distortion. Therefore, the coding distortion D becomes equal to the mean square error when the distortion difference ΔD is accumulated until the last bitplane is coded.

Simultaneously, every time when the coding of a certain pass is completed, the code amount calculating means 122 calculates the number of output bytes ΔR of the code amount R in the coding pass for each code block from the entropy coding means 103, and also calculates an accumulated code amount R=R+ΔR by accumulating the number of output bytes ΔR.

The accumulated coding distortion D which is obtained by accumulating the distortion difference ΔD, and the accumulated code amount R which is obtained by accumulating the number of output bytes ΔR are stored in the rate distortion memory 123 after indexes, such as a subband index, a code block index, and a coding pass index, are given to each of the coding distortion D and code amount R.

The slope calculating means 124 acquires the distortion difference ΔD from the coding distortion D of each coding pass which is stored in the rate distortion memory 123, acquires the number of output bytes ΔR from the code amount R of each coding pass which is stored in the rate distortion memory 123, calculates the slope S of the RD curve in the current coding pass by dividing the distortion difference ΔD by the number of output bytes ΔR, and then stores the slope S in a location of the rate distortion memory 123 which makes it possible to recognize that the slope S is associated with a coding pass which is the same as that associated with the coding distortion D and code amount R.

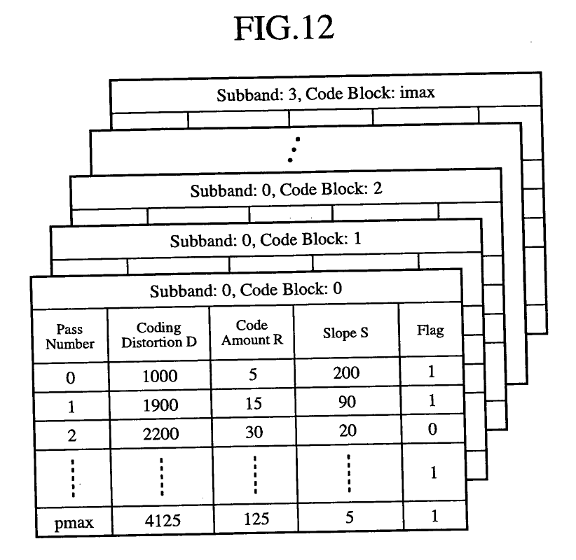

FIG. 12 is a diagram showing the data structure of an RD table stored in the rate distortion memory 123, and the pass number, coding distortion D, code amount R, slope S, and a flag of each coding pass are stored in the RD table according to combinations of a subband and a code book. The flag will be mentioned below.

The end-of-coding pass deriving means 125 then determines the ratio of the distortion difference ΔD between the coding distortion D of the current coding pass and that of a preceding coding pass which has been coded before the current coding pass is coded and whose RD curve with the current coding pass has a smaller slope S than that of the RD curve associated with preceding coding passes, to the number of output bytes ΔR, so as to define the ratio as the corrected slope S of the current coding pass, determines whether to continue to perform the coding in the current code block for a further coding pass on the basis of the total code amount Rsum in the entire screen which indicates the sum of the code amounts R of the plurality of code blocks, the corrected slope S of the current coding pass, and the inverse λ⁻¹ of the given rate control parameter, and outputs the determination result to the entropy coding means 103. When the determination result indicates that the coding in the current code block should be continued, the entropy coding means 103 codes the next coding pass, the distortion calculating means 121 calculates the distortion difference ΔD between the coding distortion D of the coding pass and the coding distortion D of the immediately-preceding coding pass, and also calculates an accumulated coding distortion D in the code block by accumulating the distortion difference ΔD, the code amount calculating means 122 counts the number of output bytes ΔR of the code amount in the coding pass, and also counts an accumulated code amount R in the code block by accumulating the number of output bytes ΔR, the slope calculating means 124 calculates the slope S of the RD curve in the coding pass, and the end-of-coding pass deriving means 125 determines the ratio of the distortion difference ΔD between the coding distortion D of the current coding pass and that of a preceding coding pass which has been coded before the current coding pass is coded and whose RD curve with the current coding pass has a smaller slope S than that of the RD curve associated with preceding coding passes, to the number of output bytes ΔR, so as to define the ratio as the corrected slope S of the current coding pass, and then determines again whether to continue to perform the coding in the current code block for a further coding pass on the basis of the total code amount Rsum in the entire screen which indicates the sum of the code amounts R of the plurality of code blocks, the corrected slope S of the current coding pass, and the inverse λ⁻¹ of the given rate control parameter. On the other hand, when determining that the coding in the current code block should not be continued, the end-of-coding pass deriving means outputs information about an end of the coding to the entropy coding means 103, and outputs an end-of-coding pass to the coded data extraction means 106.

The coded data extraction means 106 reads coded data including coded data associated with up to a coding pass which is determined by the end-of-coding pass in each code block from the code memory 104, adds the number of coding passes included in each code block, as additional information, to the read coded data, arranges them in a specified order, and outputs them as a code stream after adding predetermined header information to them.

Hereafter, the details of processing carried out by the slope calculating means 124 and end-of-coding pass deriving means 125 will be explained. In this embodiment 2, every time when they calculate the slope S in a certain coding pass, they carry out a process of correcting for the slope so that it becomes small than the slope already calculated for any other coding pass.

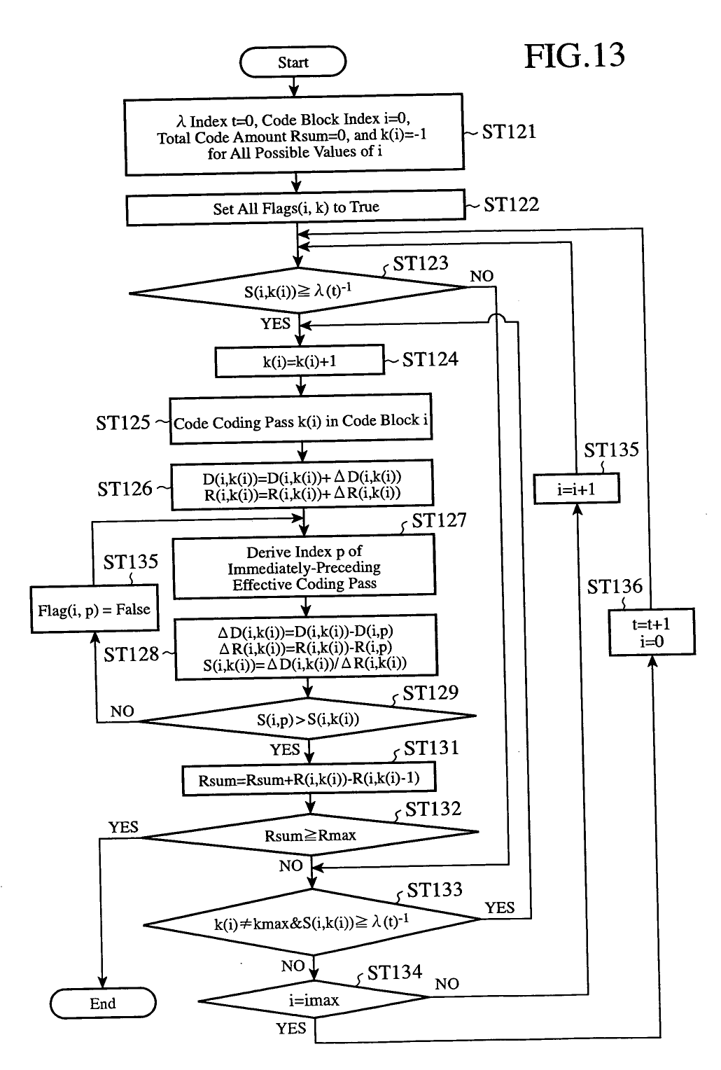

FIG. 13 is a flow chart showing a flow of the processing carried out by the image coding apparatus in accordance with embodiment 2 of the present invention.

As in the case of above-mentioned embodiment 1, candidates for the rate control parameter λ(t) are set as follows:

λ(t)={λ(0), λ(1), λ(2), . . . , λ(tmax)}

The values of the candidates for the rate control parameter λ(t) are set so as to increase monotonously, i.e., so that the following inequality: λ(t)<λ(t+1) is established. That is, the inverses λ(t)⁻¹ of the candidates for the rate control parameter Δ(t) are set so as to decrease monotonously.

In step ST121 of FIG. 13, the entropy coding means 103 makes initial settings as follows. The entropy coding means 103 sets the initial value of the index t of the rate control parameter λ to t=0 (t=0 to tmax), sets the index i of the code block to i=0 (i=0 to imax), sets the counter of the total code amount to Rsum=0, and sets a variable k(i) which stores a number specifying a coding pass to be coded for each code block to −1 for all the code blocks (the index of the next pass is 0 when the zero bitplane is skipped, k(i)=−1 to kmax, and the initial value of the variable is set to k(i)=−1 to suit the convenience of the counter used for the variable).

Although no memory is shown in the rate control information extraction means 105 in the figure, the variable k(i) is a variable for storing a number specifying a coding pass to be coded for each code block, and the index t of the rate control parameter λ, the index i of the code block, and the counter Rsum of the total code amount are variables which are common to all the code blocks.

In step ST122, the end-of-coding pass deriving means 125 sets the value of a variable flag(i,k) indicating whether to store the slope S of the RD curve in each coding pass of each code block to 1, i.e., true.

In step ST123, the end-of-coding pass deriving means 125 determines if the following inequality: S(i,k(i))>=x(t)−1 is established. Since this step ST123 is the process of determining whether or not it is necessary to code a new coding pass when the next candidate for the rate control parameter λ(t) is selected, the end-of-coding pass deriving means initially sets S(i,−1) to a sufficiently large value so that S(i,k(i)) 20>=λ(t)⁻¹ holds absolutely. In step ST124, the entropy coding means 103 increments the variable k(i) by 1 so as to prepare for the coding of the first coding pass.

In step ST125, the entropy coding means 103 codes the coding pass to be coded, which is specified by k(i), in a code block i.

In step ST126, the distortion calculating means 121 calculates the distortion difference ΔD(i,k(i)) between the coding distortion D of the current coding pass and that of the immediately-preceding coding pass in the current coding code block i, also calculates an accumulated coding distortion D(i,k(i)) by accumulating the distortion difference ΔD(i,k(i)), and then stores the accumulated coding distortion D(i,k(i)) in the rate distortion memory 123, the code amount calculating means 122 calculates the number of output bytes ΔR(i,k(i)) in the current coding pass in the current coding code block i, also calculates an accumulated code amount R(i,k(i)) by accumulating the number of output bytes ΔR(i,k(i)), and then stores the accumulated code amount R(i, k(i)) in the rate distortion memory 123.

In step ST127, the end-of-coding pass deriving means 125 derives the index p of the nearest effective coding pass which has been coded before the current coding pass is coded by detecting a coding pass whose flag(i,k) in the RD table of FIG. 12 is 1. The effective coding pass is a preceding coding pass whose slope S of the RD curve is monotonously reduced from the slope S of the RD curve of the current coding pass.

In step ST128, the end-of-coding pass deriving means 125 calculates the slope S of the RD curve associated with the current coding pass and the effective coding pass specified by the index p according to the following equation:

ΔD(i,k(i))=D(i,k(i))−D(i,p)

ΔR(i,k(i))=R(i,k(i))−R(i,p)

S(i,k(i))=ΔD(i,k(i))/ΔR(i,k(i))

where for the first coding pass 0, the slope S is set to a sufficiently large value.

In step ST129, the end-of-coding pass deriving means 125 determines whether or not the slope S(i,p(i)) in a preceding effective coding pass is larger than the slope S(i, k(i)) in the current coding pass. When the slope S(i,k(i)) in the current coding pass is equal to or larger than the slope S(i,p(i)) in the preceding effective coding pass, the end-of-coding pass deriving means 125, in step ST130, disables the front effective coding pass and changes the flag of FIG. 12 from 1 to 0. Then, the end-of-coding pass deriving means returns to step ST127, and searches for an effective coding pass which has been coded until the slope with the current coding pass monotonous decreases.

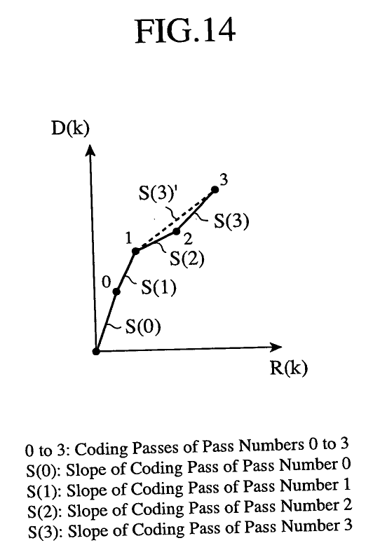

FIG. 14 is a diagram showing the correction of the slope S of the RD curve. In FIG. 14, the horizontal axis shows the code amount R(k), the vertical axis shows the coding distortion D(k), numerals 0 to 4 denote the coding passes having pass numbers 0 to 4, respectively, and S(1), S(2), S(3), and S(4) denote the slopes of the coding passes having the pass numbers 1 to 4, respectively. In this case, although all the coding passes having the pass numbers 0 to 4 are set as effective coding passes, since it is determined that the slope S(4) of the coding pass of the pass number 4 which is the current coding pass is larger than the slope S(3) of the coding pass of the pass number 3 which is the nearest effective coding pass which has been coded before the current coding pass is coded, the coding pass of the pass number 3 is disabled and the slope of the current coding pass of the pass number 4 is so corrected for as to become equal to the slope S(4)′ with the coding pass of the pass number 2. Even if this correction is made, when the slope S does not monotonously decrease yet, a further preceding effective coding pass which has been coded before the current coding pass is coded is disabled until the slope S is monotonously reduced from the slope S of any preceding coding pass.

In step ST129 of FIG. 13, when it is determined that the slope S(i,k(i)) in the current coding pass is smaller than the slope S(i,p(i)) in a preceding effective coding pass, the end-of-coding pass deriving means 125, in step ST131, adds the amount R(i,k(i))−R(i,k(i)−1) of codes which are generated in the current coding pass to the counter Rsum of the total code amount so as to calculate the total code amount Rsum including up to the code amount of the current coding pass. In step ST132, the end-of-coding pass deriving means 125 then determines whether the counter Rsum of the total code amount reaches a target code amount Rmax, and, when determining that the counter Rsum of the total code amount reaches the target code amount Rmax, outputs information about an end of the coding for each code block to the entropy coding means 103, and outputs, as an end-of-coding pass, the coding pass index k(i) indicating which up to a coding pass has been coded for each code block, to the coded data extraction means 106.

When, in step ST132, determining that the counter Rsum of the total code amount does not reach the target code amount Rmax, the end-of-coding pass deriving means 125, in step ST133, determines whether or not the slope S(i,k(i)) in the current coding pass is equal to or larger than the inverse x(t)-1 of the rate control parameter, and, when determining that the slope S(i,k(i)) is equal to or larger than λ(t)⁻¹, notifies the entropy coding means 103 that the slope S(i,k(i)) is equal to or larger than λ(t)⁻¹, and returns to step ST124 in which the entropy coding means 103 further codes the next coding pass. On the other hand, when determining that the slope S(i,k(i)) is smaller than λ(t)⁻¹, the end-of-coding pass deriving means 125 notifies the entropy coding means 103 that the slope S(i,k(i)) is smaller than λ(t)⁻¹, and the entropy coding means 103 temporarily stores coded data about the coded coding pass in the code memory 104, and aborts the coding of the current code block. In step ST134, when the code block index i is not equal to imax, the entropy coding means 103, in step ST135, increments the code block index i by 1 and then shifts the processing to the coding of the next code block.

The image coding apparatus repeats steps ST125 to ST133 similarly for the next code block, and codes the next code block until the slope S(i,k(i)) becomes smaller than the inverse λ(t)⁻¹ of the rate control parameter. After carrying out this process for all the code blocks in step ST134, the entropy coding means 103, in step ST136, increments the index t of the rate control parameter λ by 1, and sets the rate control parameter λ to the next candidate. The entropy coding means then carries out the coding of all the code blocks until the slope S(i,k(i)) becomes smaller than the inverse λ(t)⁻¹ of the rate control parameter.

There can be a case where even if the next candidate for the rate control parameter λ(t) is selected, S(i,k(i))<λ(t)⁻¹, that is, the inverse λ(t)⁻¹ of the next candidate for the rate control parameter is larger than the slope S in the already-coded coding pass. In such a case, since the next coding pass is not coded, the end-of-coding pass deriving means, in step ST123, determines that the inverse λ(t)⁻¹ of the next candidate for the rate control parameter is larger than the slope S(i,k(i)) in the already-coded coding pass, and skips the coding processing and shifts to step ST133.

In accordance with this embodiment 2, the image coding apparatus carries out the coding processing until the total code amount Rsum reaches the target code amount Rmax, as previously mentioned. As an alternative, the image coding apparatus can set a target coding distortion instead of the target code amount Rmax, and can carry out the coding processing until the sum of the coding distortions D of all code blocks in the entire screen reaches the target coding distortion.

Thus, the rate control information extraction means 105 according to embodiment 2 determines the ratio of the distortion difference ΔD between the coding distortion D of the current coding pass and that of a preceding coding pass which has been coded before the current coding pass is coded and whose RD curve with the current coding pass has a smaller slope S than that of the RD curve associated with preceding coding passes, to the number of output bytes ΔR, so as to define the ratio as the corrected slope S of the current coding pass, and calculates either the total code amount Rsum indicating the sum of the code amounts R of the code blocks or the sum of the coding distortions D of the code blocks. Then, when the total code amount Rsum reaches the target code amount Rmax or when the sum of the coding distortions D of the code blocks reaches the target coding distortion, the rate control information extraction means determines that the coding should be ended, whereas when the total code amount Rsum does not reach the target code amount Rmax or when the sum of the coding distortions D of the code blocks does not reach the target coding distortion, the rate control information extraction means makes the entropy coding means code each coding pass in the current code block until the corrected slope S becomes smaller than the inverse λ⁻¹ of the given rate control parameter, and, when the corrected slope S becomes smaller than the inverse λ⁻¹ of the rate control parameter, makes the entropy coding means code each coding pass in the next code block, and, when the coding of each coding pass in all the code blocks is completed, uses the inverse λ⁻¹ of another rate control parameter which is reduced monotonously from and which is next to the inverse λ⁻¹ of the given rate control parameter, so as to determine which up to a coding pass in which code block should be coded.

As mentioned above, since the image coding apparatus according to this embodiment 2 performs the coding processing on only a coding pass which actually outputs coded results, the amount of arithmetic operation required for the entropy coding can be further reduced as compared with conventional methods of coding all the coding passes. In addition, since the image coding apparatus according to this embodiment 2 ends the coding processing when the accumulated code amount reaches the target code amount, it does not need to carry out a convergence operation in order to make the total code amount reach the target code amount, and therefore the amount of arithmetic operation needed for rate control can be reduced.

Since the image coding apparatus additionally includes the process of correcting for the slope so that it becomes small than the slope calculated for any preceding coding pass every time when calculating the slope S after advancing to the coding of a certain coding pass, it can abort the coding of each code block at a coding pass which is closer to an optimal end-of-coding pass as compared with the end-of-coding pass provided by above-mentioned embodiment 1.

### Embodiment 3

In accordance with above-mentioned embodiments 1 and 2, the image coding apparatus calculates the slope S of the RD curve through division when calculating a truncation point according to the rate control parameter λ. In some cases, this division puts a heavy load on the coding processing. Therefore, in accordance with this embodiment 3, a method of searching for a point where Σ(R(i,k)−λD(i,k)) is maximized, i.e., searching for a point where a slope index value F given by the following equation is maximized for each code block so as to eliminate the division, thereby reducing the load of arithmetic operations for rate control.

F=R(i,k)−λD(i,k)

A block diagram showing the structure of the image coding apparatus in accordance with embodiment 3 of the present invention is the same as FIG. 4 of above-mentioned embodiment 1.

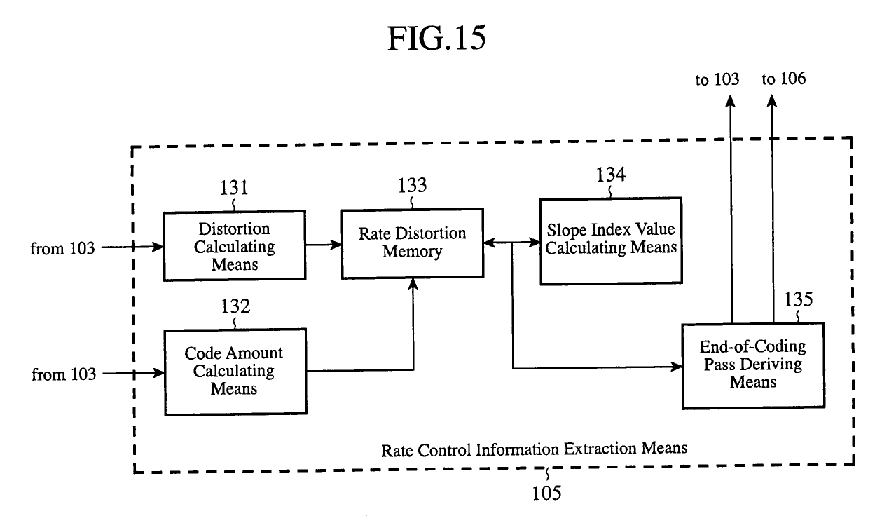

FIG. 15 is a block diagram showing the internal structure of a rate control information extraction means 105 of the image coding apparatus in accordance with embodiment 3 of the present invention. This rate control information extraction means 105 is provided with a distortion calculating means 131, a code amount calculating means 132, a rate distortion memory 133, a slope index value calculating means 134, and an end-of-coding pass deriving means 135.

This rate control information extraction means 105 determines which up to a coding pass in which code block should be coded by the entropy coding means 103 on the basis of a total code amount Rsum indicating the sum of the code amounts R of the code blocks, the code amount R of each code block, the coding distortion D of each code block, and the inverse λ⁻¹ of one of a plurality of given rate control parameters which are listed in order of monotonously decreasing, and outputs an end-of-coding pass at which the coding will be ended.

In FIG. 15, the distortion calculating means 131 calculates the difference ΔD between the coding distortion D of each coding pass from the entropy coding means 103, and the coding distortion D of an immediately-preceding coding pass from the entropy coding means 103, and also calculates an accumulated coding distortion D by accumulating the distortion difference ΔD. The code amount calculating means 132 counts the number of output bytes ΔR of the code amount R of each coding pass from the entropy coding means 103, and also counts an accumulated code amount R by accumulating the number of output bytes ΔR. The rate distortion memory 133 stores the accumulated coding distortion D which is obtained by accumulating the distortion difference ΔD, the accumulated code amount R which is obtained by accumulating the number of output bytes ΔR, the slope index value F, etc. for each coding pass. The slope index value calculating means 134 calculates the slope index value F on the basis of the coding distortion D, code amount R, and rate control parameter λ. The end-of-coding pass deriving means 135 then determines whether to continue to perform the coding for each code block so as to derive an end-of-coding pass on the basis of the total code amount Rsum in the entire screen which indicates the sum of the code amounts R of the plurality of code blocks, and the slope index value F calculated by the slope index value calculating means 134, and outputs both information indicating an end of the coding, and the end-of-coding pass.

Next, the operation of the image coding apparatus in accordance with this embodiment of the present invention will be explained.

In parallel to the processing carried out by the entropy coding means 103, every time when the coding of the certain coding pass is completed, the distortion calculating means 131 calculates the difference ΔD between the coding distortion D of a certain coding pass and the coding distortion D of an immediately-preceding coding pass for each code block, and also calculates an accumulated coding distortion D=D+ΔD by accumulating the distortion difference ΔD.

Simultaneously, for each code block, every time when the coding of a certain pass is completed, the code amount calculating means 132 calculates the number of output bytes ΔR of the code amount R in the coding pass, and also calculates an accumulated code amount R=R+ΔR by accumulating the number of output bytes ΔR. The accumulated coding distortion D and accumulated code amount R are then stored in the rate distortion memory 133 after indexes, such as a subband index, a code block index, and a coding pass index, are given to each of the coding distortion D and code amount R.

The slope index value calculating means 134 calculates the slope index value F on the basis of the coding distortion D, code amount R, and rate control parameter λ, and stores the slope index value F in a location of the rate distortion memory 133 which makes it possible to recognize that the slope index value is associated with a coding pass which is the same as that associated with the coding distortion D and code amount R.

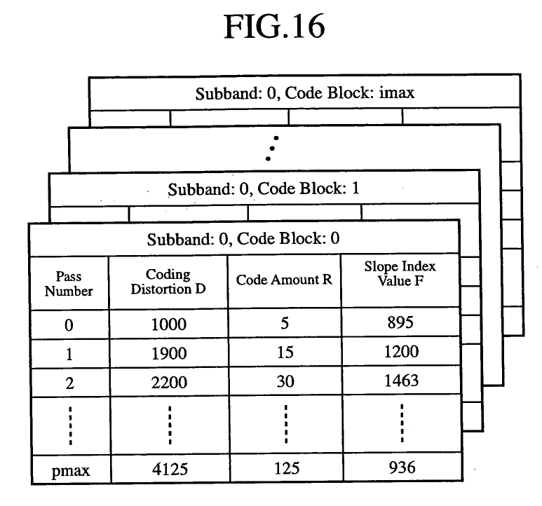

FIG. 16 is a diagram showing the data structure of an RD table stored in the rate distortion memory 133, and the pass number, coding distortion D, code amount R, and slope index value F are stored in the RD table according to combinations of a subband and a code book.

The end-of-coding pass deriving means 135 determines whether to continue to perform the coding in the current code block for a further coding pass on the basis of the total code amount Rsum in the entire screen which indicates the sum of the code amounts R of the plurality of code blocks and the slope index value F, and outputs the determination result to the entropy coding means 103. When the determination result indicates that the coding in the current code block should be continued, the entropy coding means 103 codes the next coding pass, the distortion calculating means 131 calculates the distortion difference ΔD between the coding distortion D of the coding pass and the coding distortion D of the immediately-preceding coding pass, and also calculates an accumulated coding distortion D in the code block by accumulating the distortion difference ΔD, the code amount calculating means 132 counts the number of output bytes ΔR of the code amount in the coding pass, and also counts an accumulated code amount R in the code block by accumulating the number of output bytes ΔR, and the slope index value calculating means 134 calculates the slope index value F in the coding pass. The end-of-coding pass deriving means 135 then determines again whether to continue to perform the coding in the current code block for a further coding pass. On the other hand, when determining that the coding in the current code block should not be continued, the end-of-coding pass deriving means outputs information about an end of the coding to the entropy coding means 103, and outputs an end-of-coding pass to the coded data extraction means 106.

The coded data extraction means 106 reads coded data including coded data associated with up to a coding pass which is determined by the end-of-coding pass in each code block from the code memory 104, adds the number of coding passes included in each code block, as additional information, to the read coded data, arranges them in a specified order, and outputs them as a code stream after adding predetermined header information to them.

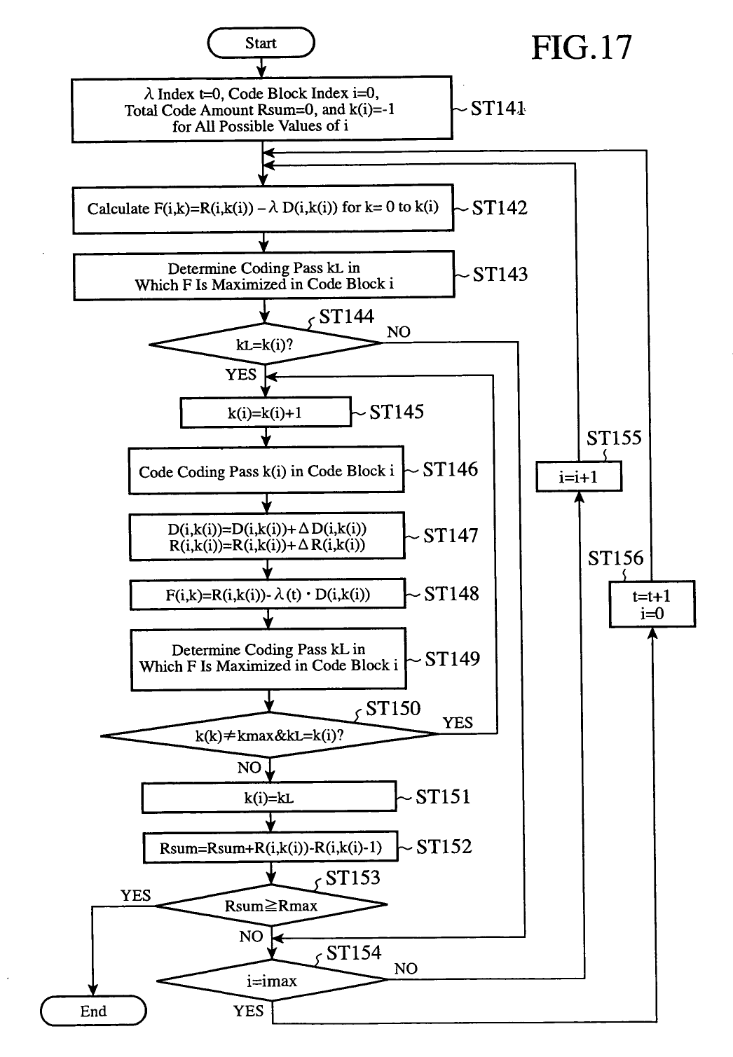

FIG. 17 is a flow chart showing a flow of the processing carried out by the image coding apparatus in accordance with embodiment 3 of the present invention.

As in the case of any of above-mentioned embodiments 1 and 2, candidates for the rate control parameter λ(t) are set as follows:

λ(t)={λ(0), λ(1), λ(2), . . . , λ(tmax)}

The values of the candidates for the rate control parameter λ(t) are set so as to increase monotonously, i.e., so that the following inequality: λ(t)<λ(t+1) is established.

In step ST141 of FIG. 17, the entropy coding means 103 sets the initial value of the index t of the rate control parameter λ to t=0 (t=0 to tmax), sets the index i of the code block to i=0 (i=0 to imax), sets the counter of the total code amount to Rsum=0, and sets a variable k(i) which stores a number specifying a coding pass to be coded for each code block to −1 for all the code blocks (the index of the next pass is 0 when the zero bitplane is skipped, k(i)=−1 to kmax, and the initial value of the variable is set to k(i)=−1 to suit the convenience of the counter used for the variable).

Although no memory is shown in the rate control information extraction means 105 in the figure, the variable k(i) is a variable for storing a number specifying a coding pass to be coded for each code block, and the index t of the rate control parameter λ, the index i of the code block, and the counter Rsum of the total code amount are variables which are common to all the code blocks.

In step ST142, the entropy coding means 103 codes a coding pass in the currently-selected code block, the distortion calculating means 131 calculates the distortion difference ΔD between the coding distortion D of the coding pass and the coding distortion D of the immediately-preceding coding pass, and also calculates an accumulated coding distortion D in the code block by accumulating the distortion difference ΔD, the code amount calculating means 132 counts the number of output bytes ΔR of the code amount in the coding pass, and also counts an accumulated code amount R in the code block by accumulating the number of output bytes ΔR, and the slope index value calculating means 134 calculates the slope index value F associated with a coded coding pass from the currently-selected candidate X(t) for the rate control parameter, and stores the slope index value F in the rate distortion memory 133.

In step ST143, the end-of-coding pass deriving means 135 derives a coding pass K_{L} in which the slope index value F associated with the code block is maximized. The end-of-coding pass deriving means 135 then, in step ST144, determines whether or not the coding pass K_{L} in which slope index value F is maximized is the current coding pass k(i). Since steps ST143 and ST144 are the process of determining whether or not it is necessary to code a new coding pass when the next candidate for the rate control parameter λ(t) is selected, the end-of-coding pass deriving means makes initial settings so that K_{L}=k(i) holds absolutely.

In step ST145, the entropy coding means 103 increments the variable k(i) by 1 so as to prepare for the coding of the first coding pass. The entropy coding means 103 then, in step ST146, codes the coding pass to be coded, which is specified by k(i), in a code block i. In step ST147, the distortion calculating means 131 calculates the distortion difference ΔD(i, k(i)) between the coding distortion D of the current coding pass and that of the immediately-preceding coding pass in the current coding code block i, also calculates an accumulated coding distortion D(i,k(i)) by accumulating the distortion difference ΔD(i,k(i)), and then stores the accumulated coding distortion D(i,k(i)) in the rate distortion memory 133, the code amount calculating means 132 calculates the number of output bytes ΔR(i,k(i)) in the current coding pass in the current coding code block i, also calculates an accumulated code amount R(i,k(i)) by accumulating the number of output bytes ΔR(i,k(i)), and then stores the accumulated code amount R(i,k(i)) in the rate distortion memory 133.

In step ST148, the slope index value calculating means 134 calculates the slope index value F(i,k) in the current coding pass according to the following equation, and stores the slope index value in the rate distortion memory 133.

F(i,k)=R(i,k(i))−λ(t)·D(i,k(i))

In step ST149, the end-of-coding pass deriving means 135 refers to the rate distortion memory 133, and derives a coding pass k_{L} in which the slope index value F(i,k) is maximized from among coding passes which have been coded in the current code block.

The end-of-coding pass deriving means 135 then, in step ST150, determines whether or not the coding pass k_{L} in which the slope index value F(i,k) is maximized is the current coding pass k(i), and, when determining that the coding pass k_{L} is the current coding pass k(i), returns to step ST145 in which the entropy coding means further codes the next coding pass. On the other hand, when determining that the coding pass k_{L} is not the current coding pass, the end-of-coding pass deriving means 135, in step ST151, determines that the coding pass which has been coded immediately before the current coding pass is coded is the coding pass k_{L} in which the slope index value F(i,k) is maximized, derives the immediately-preceding coding pass in the code block i at this time as an end-of-coding pass, stores, as the end-of-coding pass, the coding pass k_{L} into the variable k(i), and aborts the coding for the code block.

The end-of-coding pass deriving means 135 then, in step ST152, adds the amount R(i,k(i))−R(i,k(i)−1) of codes which are generated in the current coding pass to the counter Rsum of the total code amount so as to calculate the total code amount Rsum including up to the code amount of the current coding pass. In step ST153, the end-of-coding pass deriving means 135 then determines whether the total code amount Rsum reaches a target code amount Rmax, and, when determining that the total code amount Rsum reaches the target code amount Rmax, determines that it ends the coding at that time and outputs information about an end of the coding to the entropy coding means 103, and outputs, as the end-of-coding pass, the coding pass index k(i) indicating which up to a coding pass has been coded for each code block, to the coded data extraction means 106.

When, in step ST153, determining that the total code amount Rsum does not reach the target code amount Rmax, the entropy coding means 103, in step ST154 and ST155, carries out the coding processing also for each of all remaining code blocks as long as the coding pass which provides a maximum slope index value F is any coding pass other than the latest-coded coding pass. The entropy coding means 103 then, in step ST156, increments the index t of the rate control parameter λ by 1 and sets the rate control parameter λ to the next candidate, and carries out the coding processing again for each of all the code blocks until the coding pass in which the slope index value F is maximized is no longer the current coding pass.

There can be a case where even if the next candidate for the rate control parameter λ(t) is selected, the coding pass K_{L} which provides a maximum slope index value F cannot become the latest-coded coding pass at that time. In such a case, since the next coding pass is not coded, the end-of-coding pass deriving means 135, in steps ST143 and ST144, detects that the coding pass K_{L} which provides a maximum slope index value F is not the latest-coded coding pass at that time and then skips the coding processing.

In accordance with this embodiment 3, the image coding apparatus carries out the coding processing until the total code amount Rsum reaches the target code amount Rmax, as previously mentioned. As an alternative, the image coding apparatus can set a target coding distortion instead of the target code amount Rmax, and can carry out the coding processing until the sum of the coding distortions D of all code blocks in the entire screen reaches the target coding distortion.

Thus, the rate control information extraction means 105 of this embodiment 3 calculates the slope index value F for each coding pass from the sum of the code amounts R of the code block and the product of the coding distortion D of the code block and the rate control parameter λ, derives a coding pass in which the slope index value F is maximized in a certain code block, makes the entropy coding means code each coding pass in the code block as long as the derived coding pass which provides a maximum slope index value F is any coding pass other than the coding pass currently being coded. Then, when the total code amount Rsum indicating the sum of the code amounts of the code blocks reaches the target code amount Rmax or when the sum of the coding distortions D of the code blocks reaches the target coding distortion, the rate control information extraction means determines that the coding should be ended, whereas when the total code amount Rsum does not reach the target code amount Rmax or when the sum of the coding distortions D of the code blocks does not reach the target coding distortion, the rate control information extraction means makes the entropy coding means code each coding pass in the next code block, and, when the coding of each coding pass in all the code blocks is completed, uses the inverse λ⁻¹ of another rate control parameter which is reduced monotonously from and which is next to the inverse λ⁻¹ of the given rate control parameter, so as to determine which up to a coding pass in which code block should be coded.

As mentioned above, since the image coding apparatus according to this embodiment 3 performs the coding processing on only a coding pass which actually outputs coded results, the amount of arithmetic operation required for the entropy coding can be further reduced as compared with conventional methods of coding all the coding passes. In addition, since the image coding apparatus according to this embodiment 1 ends the coding processing when the total code amount reaches the target code amount, it does not need to carry out a convergence operation in order to make the total code amount reach the target code amount, and therefore the amount of arithmetic operation needed for rate control can be reduced.

Furthermore, since the image coding apparatus in accordance with this embodiment 3 uses the slope index value F which is calculated through multiplication, instead of using the slope S which is calculated through division, the load of arithmetic operations for rate control can be reduced as compared with above-mentioned embodiments 1 and 2.

### INDUSTRIAL APPLICABILITY

As mentioned above, the image coding apparatus in accordance with the present invention is suitable for reduction in the amount of arithmetic operation required for entropy coding and rate control.

1. An image coding apparatus comprising:
an entropy coding means for dividing a quantized wavelet transform coefficient for each of subbands, into which an input data is wavelet-transformed and is then split, into code blocks, for converting each of the code blocks into bit planes and dividing the bit planes into coding passes, and for coding the input data for each of the coding passes and outputting coded data;
a code memory for storing the coded data which is coded for each of the coding passes;
a rate control information extraction means for determining which up to a coding pass in which code block should be coded by said entropy coding means on a basis of either a total code amount indicating a sum of code amounts of the code blocks or a sum of coding distortions of the code blocks, a slope of an RD curve calculated from both a distortion difference between a coding distortion which occurs at a time of coding each coding pass and a coding distortion which occurs at a time of coding a preceding coding pass, and a number of output bytes of a code amount of each coding pass, and an inverse of one of a plurality of given rate control parameters which are listed in order of decreasing monotonously, and for outputting an end-of-coding pass in which the coding is ended; and
a coded data extraction means for reading coded data including up to coded data corresponding to a code pass specified by the end-of-coding pass outputted from said rate control information extraction means from said code memory, for adding a number of coding passes in each code block to the coded data read out of said code memory, and for outputting them as a code stream.

2. The image coding apparatus according to claim 1, characterized in that a rate control means calculates the slope of the RD curve from both the distortion difference between the coding distortion which occurs at the time of coding each coding pass and the coding distortion which occurs at the time of coding a previous coding pass, and the number of output bytes of the code amount of each coding pass, and also calculates one of the total code amount indicating the total code amount of each code block and the sum of the coding distortions of the code blocks, and, when said total code amount reaches a target code amount or when the sum of the coding distortions of the code blocks reaches a target coding distortion, determines that the coding should be ended, whereas when said total code amount does not reach the target code amount or when the sum of the coding distortions of the code blocks does not reach the target coding distortion, causes said entropy coding means to, until said slope becomes smaller than an inverse of a given rate control parameter, perform coding for each coding pass in a corresponding code block, and, when said slope then becomes smaller than the inverse of the given rate control parameter, causes said entropy coding means to perform coding for each coding pass in a next code block code and, when the coding of each coding pass in each of all the code blocks is completed, uses the inverse number of other rate control parameters which show the value of monotone decreasing from the inverse number of the rate control parameter given so as to determines which coding pass in which code block codes.

3. The image coding apparatus according to claim 1, characterized in that the rate control information extraction means determines a ratio of a distortion difference between a coding distortion of a current coding pass and that of a preceding coding pass which has been coded before the current coding pass is coded and whose RD curve with the current coding pass has a smaller slope than that of an RD curve associated with preceding coding passes, to the number of output bytes, so as to define the ratio as a corrected slope of the current coding pass, calculates either a total code amount indicating a sum of code amounts of the code blocks or a sum of coding distortions of the code blocks, when the total code amount reaches a target code amount or when the sum of the coding distortions of the code blocks reaches a target coding distortion, determines that the coding should be ended, whereas when the total code amount does not reach the target code amount or when the sum of the coding distortions of the code blocks does not reach the target coding distortion, makes the entropy coding means code each coding pass in the current code block until the corrected slope becomes smaller than the inverse of the given rate control parameter, and, when the corrected slope becomes smaller than the inverse of the rate control parameter, makes the entropy coding means code each coding pass in a next code block, and, when the coding of each coding pass in all the code blocks is completed, uses an inverse of another rate control parameter which is reduced monotonously from and which is next to the inverse of the given rate control parameter, so as to determine which up to a coding pass in which code block should be coded.

4. An image coding apparatus comprising:
an entropy coding means for dividing a quantized wavelet transform coefficient for each of subbands, into which an input data is wavelet-transformed and is then split, into code blocks, for converting each of the code blocks into bit planes and dividing the bit planes into coding passes, and for coding the input data for each of the coding passes and outputting coded data;
a code memory for storing the coded data which is coded for each of the coding passes;
a rate control information extraction means for determining which up to a coding pass in which code block should be coded by said entropy coding means on a basis of either a total code amount indicating a sum of code amounts of the code blocks or a sum of coding distortions of the code blocks, the code amount of each of the code blocks, the coding distortion of each of the code blocks, and an inverse of one of a plurality of given rate control parameters which are listed in order of decreasing monotonously, and for outputting an end-of-coding pass in which the coding is ended; and
a coded data extraction means for reading coded data including up to coded data corresponding to a code pass specified by the end-of-coding pass outputted from said rate control information extraction means from said code memory, for adding a number of coding passes in each code block to the coded data read out of said code memory, and for outputting them as a code stream.

5. The image coding apparatus according to claim 4, characterized in that the rate control information extraction means calculates a slope index value of each of the coding passes from a sum of the code amounts of the code blocks, and a product of the coding distortions of the code block and the rate control parameter, derives a coding pass whose slope index value is a largest one of those of any other coding passes in a certain code block, makes the entropy coding means code each coding pass in the code block until the coding pass whose slope index value is the largest one of those of any other coding passes in the certain code block is no longer a coding pass currently being coded, and, when the total code amount reaches a target code amount or when the sum of the coding distortions of the code blocks reaches a target coding distortion, determines that the coding should be ended, whereas when said total code amount does not reach the target code amount or when the sum of the coding distortions of the code blocks does not reach the target coding distortion, makes the entropy coding means code each coding pass in a next code block, and, when the coding of each coding pass in all the code blocks is completed, uses another rate control parameter which is reduced monotonously from and which is next to the inverse of the given rate control parameter, so as to determine which up to a coding pass in which code block should be coded.
